(19) United States
(12) Patent Application Publication
(10) Pub. No.: US 2015/0016918 A1
(43) Pub. Date: Jan. 15, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventor: Joel Colombo, Howell, MI (US)

(21) Appl. No.: 13/939,503

(22) Filed: Jul. 11, 2013

(51) Int. Cl. F16B 29/00

(52) U.S. Cl. CPC F16B 29/00
USPC 411/22

(57) ABSTRACT

In one aspect an elastically averaged alignment system is provided. The alignment system includes a first component comprising an inner wall defining an alignment aperture, a second component including a receiving aperture, and a fastener configured for insertion into the alignment aperture and the receiving aperture to couple the first and second components. The system further includes an elastically deformable collar inserted onto the fastener. The collar is configured to elastically deform against the inner wall to an elastically averaged final configuration upon insertion into the alignment aperture, thereby coupling the first and second components to facilitate aligning the first component and the second component in a desired orientation.

### FIELD OF THE INVENTION

The subject invention relates to matable components and, more specifically, to elastically averaged matable components for alignment.

### BACKGROUND

Some known components, in particular some vehicular components, which are to be mated together in a manufacturing process may be mutually located with respect to each other by alignment features that are oversized holes and undersized threaded bolts. Such alignment features are typically sized to provide spacing to freely move the components relative to one another to align them without creating an interference therebetween that would hinder the manufacturing process. One such example includes the use of threaded bolts, which are received into corresponding female alignment features, typically apertures in the form of slots or holes. The components are formed with a predetermined clearance between the threaded bolts and their respective female alignment features to match anticipated size and positional variation tolerances of the alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly (i.e., manufacturing stack-up). Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling, and further result in the perception of poor quality.

### SUMMARY OF THE INVENTION

In one aspect an elastically averaged alignment system is provided. The alignment system includes a first component comprising an inner wall defining an alignment aperture, a second component including a receiving aperture, and a fastener configured for insertion into the alignment aperture and the receiving aperture to couple the first and second components. The system further includes an elastically deformable collar inserted onto the fastener. The collar is configured to elastically deform against the inner wall to an elastically averaged final configuration upon insertion into the alignment aperture, thereby coupling the first and second components to facilitate aligning the first component and the second component in a desired orientation.

In another aspect a vehicle is provided. The vehicle includes a body and an elastically averaged alignment system integrally arranged within the body. The elastically averaged alignment system includes a first component including an inner wall defining an alignment aperture, a second component including a receiving aperture, and a fastener configured for insertion into the alignment aperture and the receiving aperture to couple the first and second component. The alignment system further includes an elastically deformable collar inserted onto the fastener. The collar is configured to elastically deform against the inner wall to an elastically averaged final configuration upon insertion into the alignment aperture, thereby coupling the first and second components to facilitate aligning the first component and the second component in a desired orientation

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary disassembled elastically averaged alignment system;

FIG. 2 is a cross-sectional view of the elastically averaged alignment system shown in FIG. 1 and taken along line 2-2 of FIG. 1;

FIG. 3 is a cross-sectional view of the elastically averaged alignment system shown in FIGS. 1 and 2 following assembly;

FIG. 4 is a perspective view of an exemplary elastically deformable collar used in the system shown in FIGS. 1-3;

FIG. 5 is a cross-sectional view of the elastically deformable collar shown in FIG. 4 and taken along line 5-5 of FIG. 4;

FIG. 6 is a perspective view of another exemplary elastically deformable collar that may be used in the system shown in FIG. 1;

FIG. 7 is a cross-sectional view of the elastically deformable collar shown in FIG. 6 and taken along line 7-7 of FIG. 6;

FIG. 8 is a perspective view of yet another exemplary elastically deformable collar that may be used in the system shown in FIG. 1;

FIG. 9 is a perspective view of the elastically deformable collar shown in FIG. 8 and including a plurality of locking teeth;

FIG. 10 is a side view of a vehicle that may use any of the embodiments shown in FIGS. 1-9;

FIG. 11 is a cross-sectional view of another exemplary elastically averaged alignment system that may be used with the vehicle shown in FIG. 10; and

FIG. 12 is a side view of an exemplary side mirror and vehicle body shown in FIG. 11, before assembly.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=x/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are alignment systems and methods for elastically averaged mating assemblies. The alignment systems include elastically deformable collars that are fitted to a fastener that is inserted into two or more components. The collar facilitates elastic averaging between components during fastener insertion, thereby resulting in proper alignment between the components.

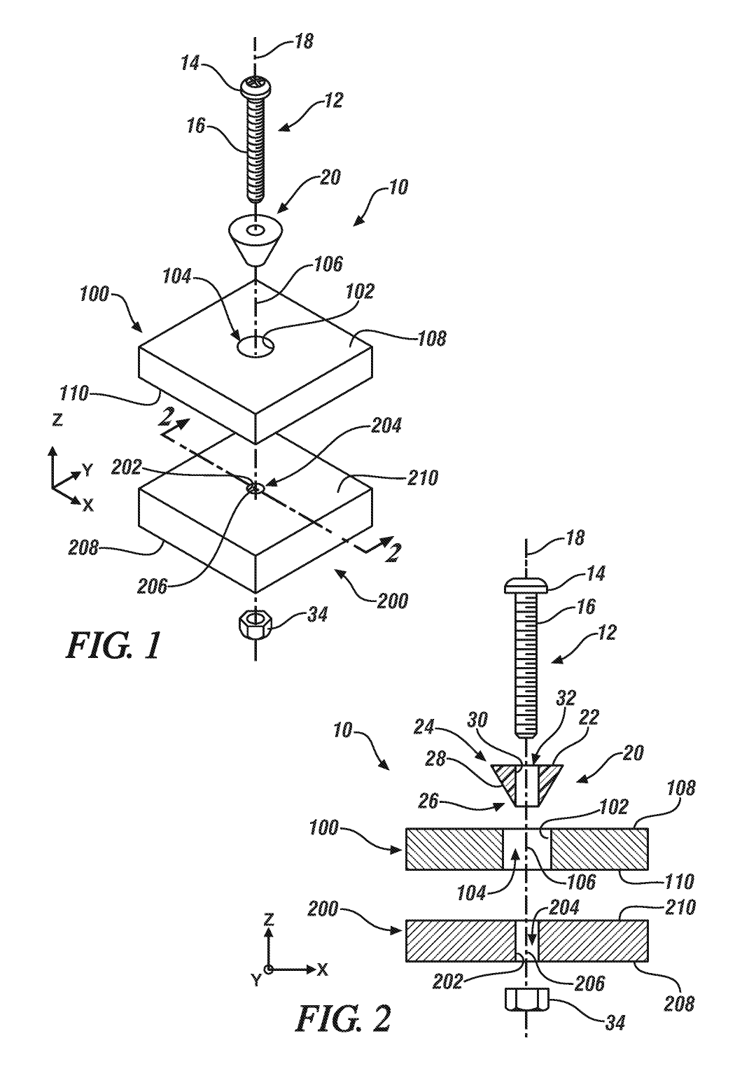

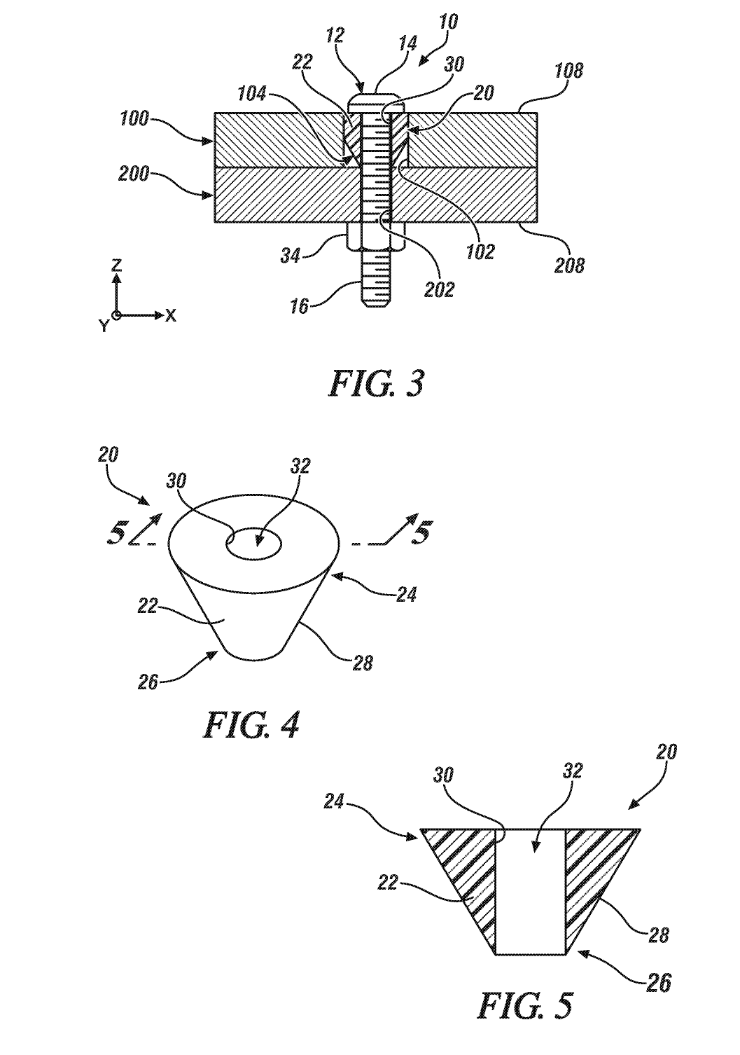

FIGS. 1-3 illustrate an exemplary elastically averaged alignment system 10 that generally includes a first component 100 to be mated to a second component 200 utilizing a fastener 12 and an elastically deformable collar 20. First component 100 includes an inner wall 102 defining an alignment aperture 104 having a centerline 106, and second component 200 includes an inner wall 202 defining a receiving aperture 204 having a centerline 206. Alignment aperture 104 is generally aligned with receiving aperture 204 for insertion of fastener 12 therethrough. Although a single pair of corresponding alignment aperture 104 and receiving aperture 204 is illustrated, components 100 and 200 may have any number and combination of corresponding apertures 104 and 204.

In the exemplary embodiment, first component 100 includes an outer face 108 and an inner face 110 and is fabricated from a rigid material such as plastic. However, first component 100 may be fabricated from any suitable material that enables system 10 to function as described herein. In addition, inner face 110 may include one or more tabs or flanges (not shown) at least partially circumscribing alignment aperture 104 and extending outwardly from inner face 110 that are formed during a punching or a similar process used to form alignment aperture 104. In the exemplary embodiment, alignment aperture 104 has a generally circular cross-section. Alternatively, alignment aperture 104 may have any shape that enables system 10 to function as described herein. For example, alignment aperture 204 may be an elongated slot (e.g., similar to the shape of elastic tube alignment system described in co-pending U.S. patent application Ser. No. 13/187,675 and particularly illustrated in FIG. 13 of the same). Second component 200 includes an outer face 208 and an inner face 210 and is similarly fabricated from a rigid material, for example, sheet metal. However second component 200 may be fabricated from any suitable material that enables system 10 to function as described herein.

While not being limited to any particular structure, first component 100 may be a decorative trim component of a vehicle with the customer-visible side being outer face 108, and second component 200 may be a supporting substructure that is part of, or is attached to, the vehicle and on which first component 100 is fixedly mounted in precise alignment.

In the exemplary embodiment, fastener 12 is a threaded bolt having a head portion 14, a threaded shank portion 16, and a centerline 18. Alternatively, fastener 12 may be any suitable fastener that enables system 10 to function as described herein. It is important to note that the diameter of shank portion 16 is smaller than the diameter or cross-section of alignment aperture 104. In known components, the threaded fastener is undersized and a component aperture is oversized to enable one component to move relative to the other to manually orient the components. Elastically deformable collar 20 may facilitate substantial alignment of centerlines 18, 106, and 206, as is described herein in more detail. However, centerlines 18, 106, and/or 206 may be slightly offset due to the elastic averaging over the entire system 10.

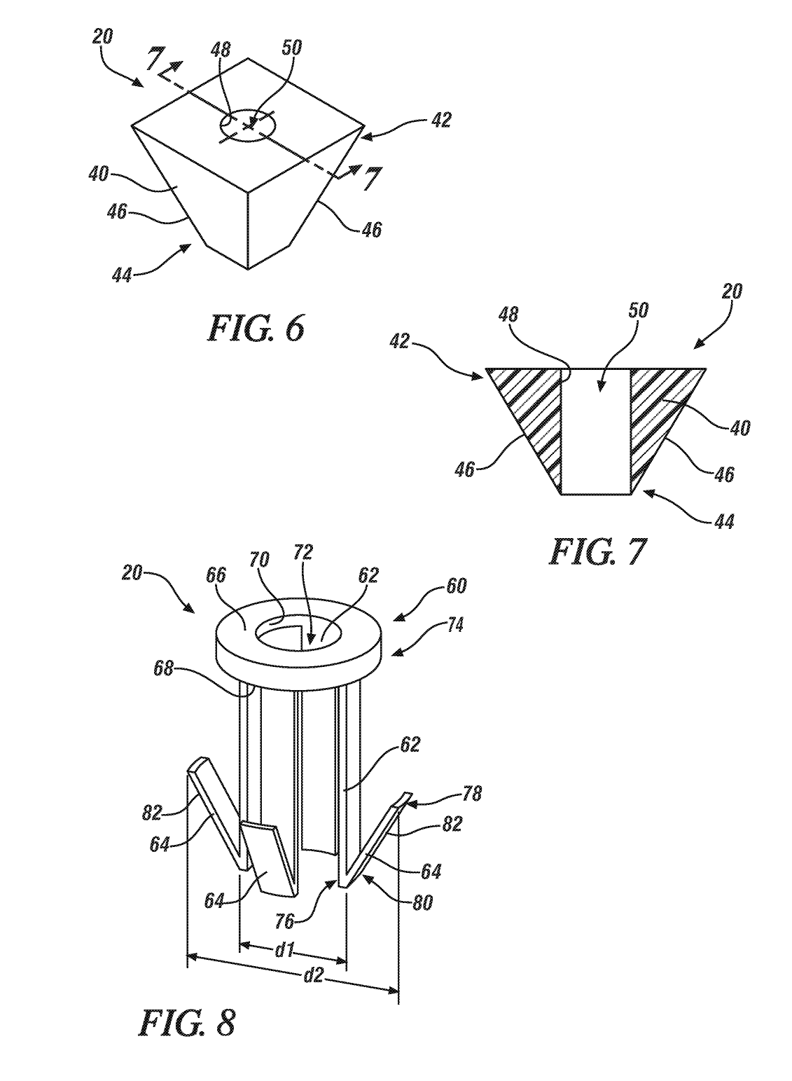

In the exemplary embodiment, and with further reference to FIGS. 4 and 5, elastically deformable collar 20 includes a body 22 having a first end 24, a second end 26, an outer wall 28, and an inner wall 30 defining an aperture 32. Outer wall 28 is generally tapered such that a cross-section of collar 20 proximate first end 24 is larger than a cross-section of collar 20 proximate second end 26. In the exemplary embodiment, body 22 is substantially conical. Alternatively, body 22 may have any tapered shape that enables elastically deformable collar 20 to function as described herein. For example, body 22 may be substantially pyramidal as illustrated in FIGS. 6 and 7, and as described herein in more detail.

Elastically deformable collar aperture 32 is sized to receive threaded shank 16 through first end 24 such that fastener head portion 14 seats against first end 24. Alternatively, collar 20 may be formed integrally with fastener 12. Collar 20 and fastener 12 are then insertable into alignment aperture 104. Elastically deformable collar 20 is configured and disposed to interferingly, deformably, and matingly engage alignment aperture 104, as discussed herein in more detail, to precisely align first component 100 with second component 200 in two or four directions, such as the +/− x-direction and the +/− y-direction of an orthogonal coordinate system, for example, which is herein referred to as two-way and four-way alignment.

To provide an arrangement where elastically deformable collar 20 is configured and disposed to interferingly, deformably and matingly engage alignment aperture 104, the diameter or cross-section of alignment aperture 104 is less than the diameter or cross-section of collar body first end 24, which necessarily creates a purposeful interference fit between elastically deformable collar 20 and alignment aperture 104. As such, when inserted into alignment aperture 104, portions of the elastically deformable collar 20 elastically deform to an elastically averaged final configuration that substantially aligns fastener centerline 18, alignment aperture centerline 106, and receiving aperture centerline 206 in four planar orthogonal directions (the +/− x-direction and the +/− y-direction). Where alignment aperture 104 is an elongated slot (not shown), centerlines 18, 106 and 206 are aligned in two planar orthogonal directions (the +/− x-direction or the +/− y-direction). In the exemplary embodiment, a threaded nut 34 is threaded to threaded shank 16 after insertion of fastener 12 into alignment aperture 104 and receiving aperture 204. Threading of nut 34 onto shank 16 facilitates drawing collar 20 into alignment aperture 104 where it is elastically deformed and aligns and secures components 100 and 200 in a desired orientation. Alternatively, or in addition, receiving aperture 204 may be threaded and threaded shank 16 threads directly therein to facilitate drawing collar 20 into alignment aperture 104.

While FIGS. 1-3 depict a single elastically deformable collar 20 in a corresponding circular alignment aperture 104 to provide four-way alignment of the first component 100 relative to the second component 200, it will be appreciated that the scope of the invention is not so limited and encompasses other quantities and types of elastically deformable alignment elements used in conjunction with elastically deformable collar 20 and corresponding alignment aperture 104.

FIGS. 6 and 7 illustrate an alternative embodiment of elastically deformable collar 20 that is similar to the collar shown in FIGS. 1-5, but includes a generally pyramidal body 40. In the exemplary embodiment, pyramidal body 40 includes a first end 42, a second end 44, outer walls 46, and an inner wall 48 defining an aperture 50. Outer walls 46 are generally tapered such that a cross-section of collar 20 proximate first end 42 is larger than a cross-section of collar 20 proximate second end 44. While pyramidal body 40 is illustrated with four outer walls 46, body 40 may have any number of outer walls 46. For example, pyramidal body may have three or five outer walls 46. Elastically deformable collar aperture 50 is sized to receive threaded shank 16 through first end 42 such that fastener head portion 14 is seated against first end 42. Collar 20 is configured and disposed to interferingly, deformably, and matingly engage alignment aperture 104 to precisely align first component 100 with second component 200 in two or four directions, such as the +/− x-direction and the +/− y-direction of an orthogonal coordinate system.

FIG. 8 illustrates another alternative embodiment of elastically deformable collar 20. In the exemplary embodiment, collar 20 generally includes a collar portion 60, a plurality of arms 62, and a plurality of biasing arms 64. Collar portion 60 is generally annular and includes a first surface 66, an opposite second surface 68, and an inner wall 70 defining an aperture 72. Alternatively, collar portion 60 may have any suitable shape such as, for example, a generally square shape. The diameter or cross-section of collar portion 60 is larger than the diameter or cross-section of alignment aperture 104, and at least a portion of second surface 68 may seat against outer surface 108 after insertion of collar 20. Arms 62 extend from second surface 68 and each includes a proximal end 74 coupled to collar second surface 68 and a distal end 76. Each biasing arm 64 extends angularly from one arm 62 and includes a first end 78 and a second end 80 coupled to arm proximal end 74. In the exemplary embodiment, collar 20 includes four sets of arms 62 and biasing arms 64. However, collar 20 may have any number of arms 62 and biasing arms 64 that enables system 10 to function as described herein.

Biasing arms 64 define a generally tapered surface 82 having a first diameter d1 proximate second end 80 that is smaller than a second diameter d2 proximate first end 78. Aperture 72 is sized to receive threaded shank 16 such that fastener head portion 14 is seated against first surface 66. As collar 20 is inserted into alignment aperture 104 (as shown in FIGS. 1-3), tapered surface 82 contacts inner wall 104 due to the increasing diameter from d1 to d2, and arms 62 and/or biasing arms 64 elastically deform inward toward centerline 106. Accordingly, arms 62 and/or biasing arms 64 are configured and disposed to interferingly, deformably, and matingly engage inner wall 202 alignment aperture 104 to precisely align first component 100 with second component 200 in two or four directions, such as the +/− x-direction and the +/− y-direction of an orthogonal coordinate system.

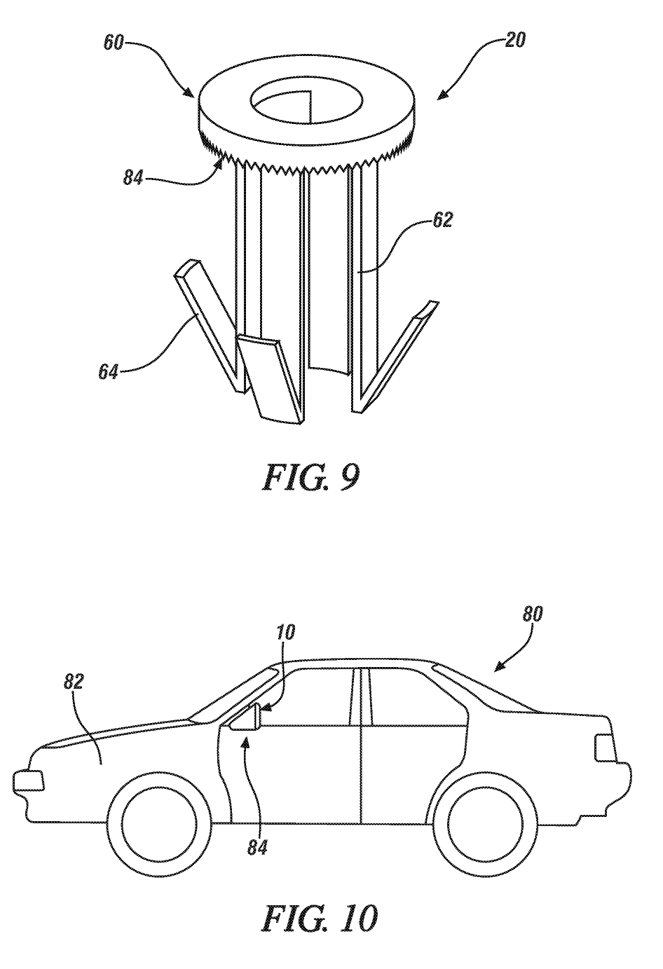

Additionally, as shown in FIG. 9, collar portion 60 may include a plurality of teeth 84 to facilitate engagement (e.g., locking) between fastener 12 and first component outer surface 108 to prevent torsion of fastener 12 once fastener 12 is tightened to secure components 100 and 200. Alternatively, collar portion 60 may have any suitable locking feature that enables collar portion 60 to resist torsion or loosening of fastener 12. For example, collar portion 60 may include any type of lock washer structure.

In view of the foregoing, and with reference to FIG. 10, it will be appreciated that an embodiment of the invention also includes a vehicle 80 having a body 82 with an elastically averaged alignment system 10 as herein disclosed integrally arranged with the body 82. In the embodiment of FIG. 10, the elastically averaged alignment system 10 is depicted forming at least a portion of a side mirror 84 of the vehicle 80. However, it is contemplated that an elastically averaged alignment system 10 as herein disclosed may be utilized with other features of the vehicle 80, such as chassis components, interior components, and powertrain components.

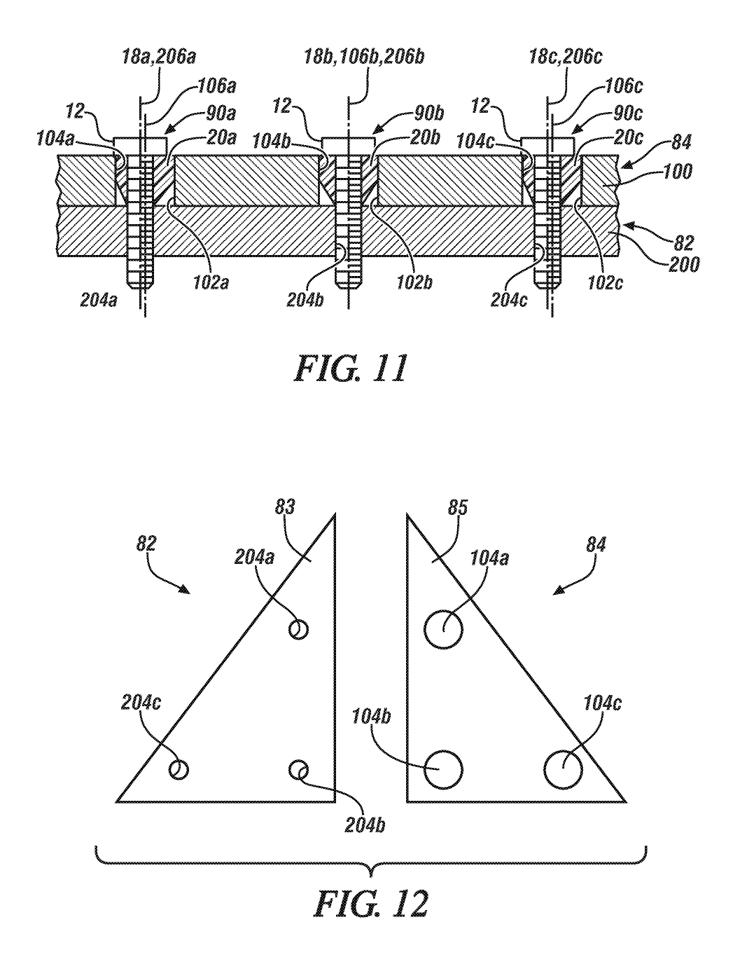

FIG. 11 illustrates an exemplary illustration of elastically averaged alignment system 10 for the coupling between a portion of side mirror 84 and vehicle body 82 shown in FIG. 10. As shown, a plurality of fastener and collar configurations 90a, 90b, and 90c are inserted into a plurality of corresponding alignment apertures 104a, 104b, 104c and receiving apertures 204a, 204b, 204c. Collars 20a, 20b, and 20c facilitate elastic averaging over the total of fasteners 12 to facilitate aligning centerlines 18, 106, and 206 leading to an improved coupling between first component 100 and second component 200. As shown with collar pairing 90b, collar 20b elastically deforms within alignment aperture 104b to align centerlines 18b, 106b, and 206b. Due, for example, to the manufacturing tolerance and variance of oversized alignment apertures 104a-c, alignment aperture centerlines 106a and 106c are actually formed farther from centerline 106b than designed. Collars 20a and 20c elastically deform within respective alignment apertures 104a and 104c to facilitate bringing centerlines 106a and 106c more in-line with respective centerlines 18a, 206a and 18c, 206c. As shown, the left portion of collars 20a, 20c deforms more than the right portion of collars 20a, 20c to substantially align the centerlines such that centerlines 104a, 104c are only slightly off-set from respective centerlines 18a, 206a and 18c, 206c. Accordingly, collar and fastener configurations 90a, 90b, 90c elastically average the alignment features of first and second components 100, 200 to couple them in a desired orientation.

FIG. 12 illustrates an exemplary illustration of the orientation of alignment apertures 104a, 104b, and 104c of side mirror 84 and receiving apertures 204a, 204b, and 204c of vehicle body 82. As shown, a portion of vehicle body 82 such as a door sheet metal 83 is substantially triangular with a receiving aperture 204 located proximate each corner of the triangular shape. Similarly, a portion of side mirror 84 such as a base 85 is substantially triangular with alignment apertures 104 located proximate each corner of the triangular shape. As previously described, collars 90 are inserted into alignment apertures 104 and receiving apertures 204 to couple side mirror 84 to vehicle body 82.

Systems and methods for elastically averaged mating assemblies are described herein. The systems generally include a first component with an alignment aperture, a second component with a receiving aperture corresponding to the alignment aperture, a fastener, and an elastically deformable collar. The fastener is inserted into the collar and the two are inserted into the alignment aperture and receiving aperture. The collar elastically deforms against the walls of the alignment aperture to facilitate centering the fastener relative to the center of the alignment aperture to precisely mate the components in a desired orientation. Accordingly, the mating of the first and second components is elastically averaged over a corresponding pair or pairs of deformable collars and alignment apertures.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an inner wall defining an alignment aperture;
a second component comprising a receiving aperture;
a fastener configured for insertion into said alignment aperture and said receiving aperture to couple said first and second components; and
an elastically deformable collar inserted onto said fastener, said collar configured to elastically deform against said inner wall to an elastically averaged final configuration upon insertion into said alignment aperture, thereby coupling said first and second components to facilitate aligning said first component and said second component in a desired orientation.

2. The system of claim 1, wherein said elastically deformable collar is tapered.

3. The system of claim 1, wherein said elastically deformable collar is substantially conical or substantially pyramidal.

4. The system of claim 1, wherein said fastener comprises a head portion and a shank portion, said shank portion having a cross-section smaller than a cross-section of said alignment aperture.

5. The system of claim 4, wherein said fastener further comprises a first centerline and said alignment aperture comprises a second centerline, wherein when said fastener couples said first and second components, said elastically deformable collar elastically deforms against said alignment aperture inner wall to substantially align said first centerline and said second centerline.

6. The system of claim 1, wherein said receiving aperture is threaded, said fastener configured with complementary threads to couple said first and second components by threading into said threaded receiving aperture.

7. The system of claim 1, wherein said collar comprises a collar portion, a plurality of arms extending from said collar portion, and a biasing arm extending from each of said arms, wherein said biasing arms are configured to elastically deform against said alignment aperture inner wall when said fastener couples said first and second components.

8. The system of claim 7, wherein at least a portion of said collar portion includes a lock washer structure to facilitate engagement between said fastener and said first component.

9. A vehicle comprising:
a body; and
an elastically averaged alignment system integrally arranged within said body, said elastically averaged alignment system comprising:
a first component comprising an inner wall defining an alignment aperture;
a second component comprising a receiving aperture;
a fastener configured for insertion into said alignment aperture and said receiving aperture to couple said first and second components; and
an elastically deformable collar inserted onto said fastener, said collar configured to elastically deform against said inner wall to an elastically averaged final configuration upon insertion into said alignment aperture, thereby coupling said first and second components to facilitate aligning said first component and said second component in a desired orientation.

10. The vehicle of claim 9, wherein said elastically deformable collar is substantially conical or substantially pyramidal.

11. The vehicle of claim 9, wherein said fastener comprises a head portion and a shank portion, said shank portion having a cross-section smaller than a cross-section of said alignment aperture.

12. The vehicle of claim 11, wherein said fastener further comprises a first centerline and said alignment aperture comprises a second centerline, wherein when said fastener couples said first and second components, said elastically deformable collar elastically deforms against said alignment aperture inner wall to substantially align said first centerline and said second centerline.

13. The vehicle of claim 9, wherein said collar comprises a collar portion, a plurality of arms extending from said collar portion, and a biasing arm extending from each of said arms, wherein said biasing arms are configured to elastically deform when said fastener couples said first and second components.

14. The vehicle of claim 9, wherein said first component is a side mirror and said body comprises said second component.
